(19) United States
(12) Patent Application Publication
(10) Pub. No.: US 2012/0143623 A1
(43) Pub. Date: Jun. 7, 2012

(54) RULE BASED DECISION SUPPORT AND PATIENT-SPECIFIC VISUALIZATION SYSTEM FOR OPTIMAL CANCER STAGING

(75) Inventors: Roland Johannes Opfer, Hamburg (DE); Cristian Lorenz, Hamburg (DE); Rafael Wiemker, Kisdorf (DE); Lothar Spies, Hamburg (DE); Guy Shechter, Briarcliff Manor, NY (US)

(73) Assignee: KONINKLIJKE PHILIPS ELECTRONICS N.V., EINDHOVEN (NL)

(21) Appl. No.: 13/382,013

(22) PCT Filed: Jun. 15, 2010
(86) PCT No.: PCT/IB2010/052670

§ 371 Date: Feb. 23, 2012

Related U.S. Application Data
(60) Provisional application No. 61/222,675, filed on Jul. 2, 2009.

(51) Int. Cl. G06Q 50/22

(52) U.S. Cl. 705/2

(57) ABSTRACT

A system including a display and a processor and a corresponding method for identifying a tumor in a patient image, classifying the tumor based on a predetermined classification system and determining a recommendation regarding a lymph node biopsy based on the tumor identified in the patient image, the classification of the tumor and a predetermined rule.

Lung cancer staging is the assessment of the degree to which lung cancer has spread from its original source. Correct staging of lung cancer is extremely important for the treatment planning process. Lung cancer spreads in a fairly predictable pattern. A tumor may initially be discovered in various portions of the lung. The cancer then generally spreads to lymph nodes close to the original tumor, followed by lymph nodes further away in a space called the mediastinum. Initially, in the mediastinum, cancer will infect lymph nodes on the same side as the tumor. However, as the cancer progresses, the cancer may spread to lymph nodes on the opposite side of the tumor. In very advanced stages, lung cancer may spread to distant organs. By determining how far the cancer has spread, a cancer stage can be determined and a proper course of treatment may be planned.

The TNM (Tumor Node Metastasis) classification system is an internationally accepted staging system, which classifies the degree of severity of the cancer. An internationally accepted classification system facilitates the exchange of information between treatment facilities and contributes to the appropriate treatment of cancer. The ‘T’ (tumor) indicates the size or direct extent of the primary tumor. The ‘N’ (lymph nodes) indicates the involvement of regional lymph nodes. The ‘M’ indicates whether distant metastasis (e.g., the spread of cancer from one body part to another) exists. Thus, after a tumor is initially identified and classified, surrounding lymph nodes may be biopsied to determine the extent that the cancer has spread for accurate cancer staging.

A method for identifying a tumor in a patient image, classifying the tumor based on a predetermined classification system and determining a recommendation regarding a lymph node biopsy based on the tumor identified in the patient image, the classification of the tumor and a predetermined rule.

A system having a display displaying a patient image, a processor classifying a tumor displayed in the patient image based on a predetermined classification system and determining a recommendation regarding a lymph node biopsy based on the tumor in the patient image, the classification of the tumor and a predetermined rule.

A computer-readable storage medium including a set of instructions executable by a processor. The set of instructions operable to identify a tumor in a patient image, classify the tumor based on a predetermined classification system and determine a recommendation regarding a lymph node biopsy based on the tumor identified in the patient image, the classification of the tumor and a predetermined rule.

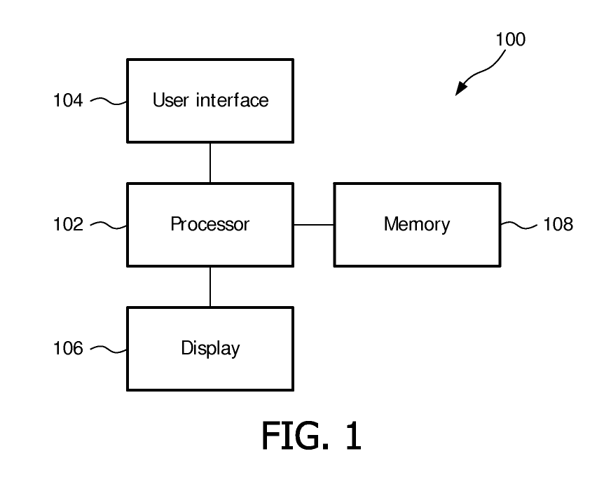

FIG. 1 shows a schematic diagram of a system according to an exemplary embodiment.

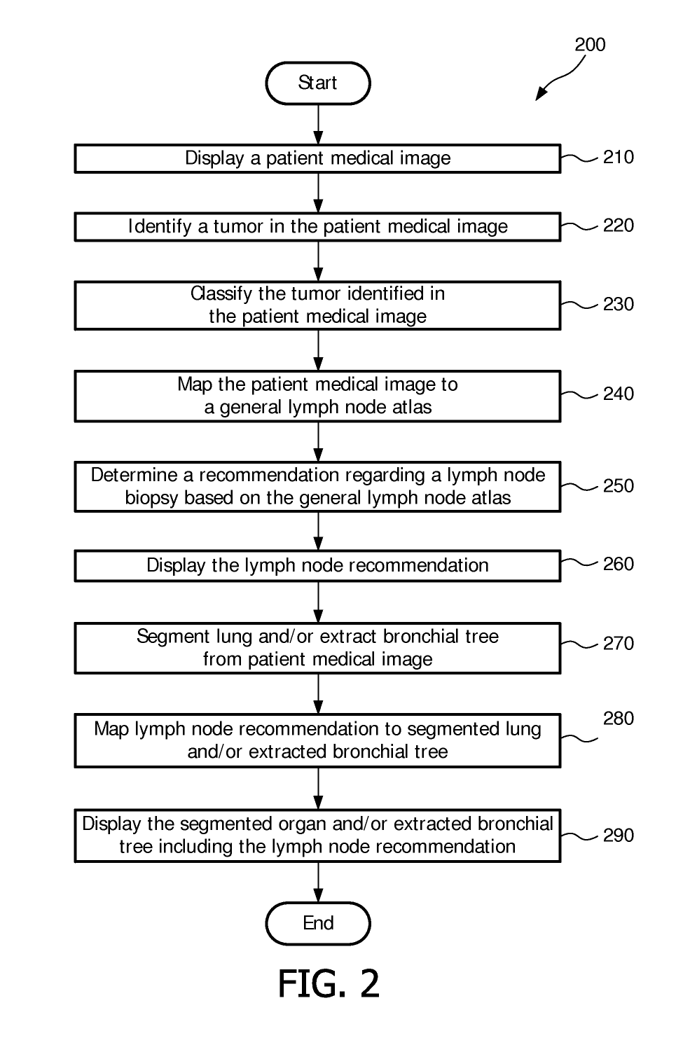

FIG. 2 shows a flow diagram of a method according to an exemplary embodiment.

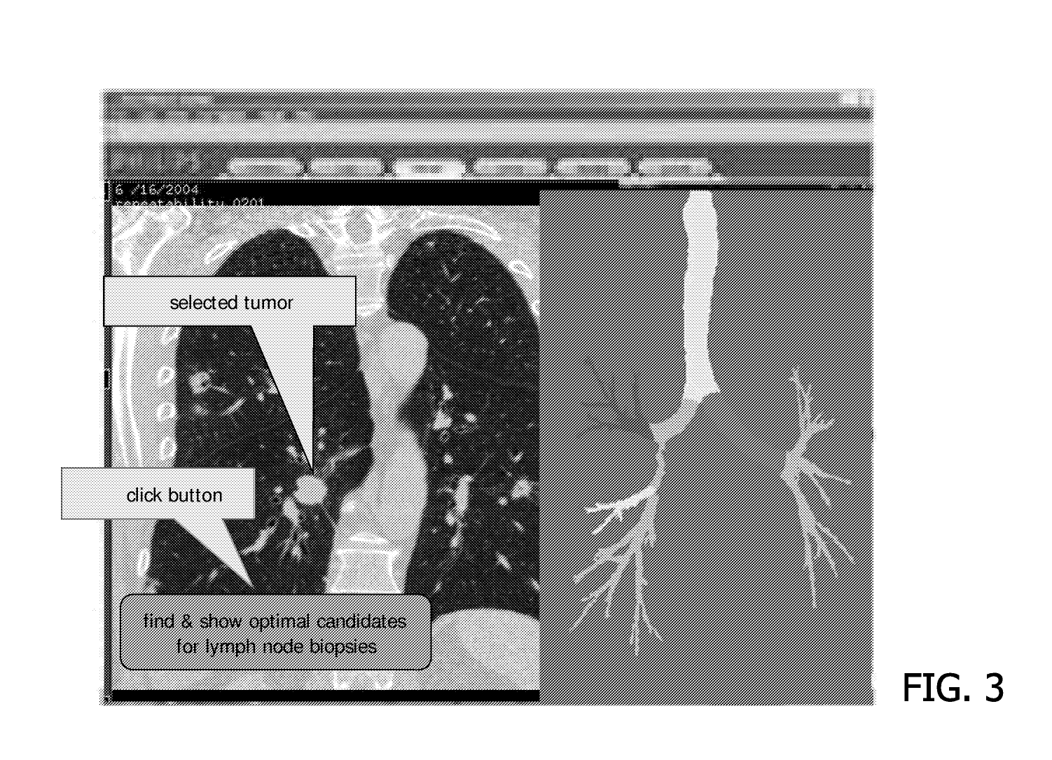

FIG. 3 shows a screen shot of a tumor identified in a medical image.

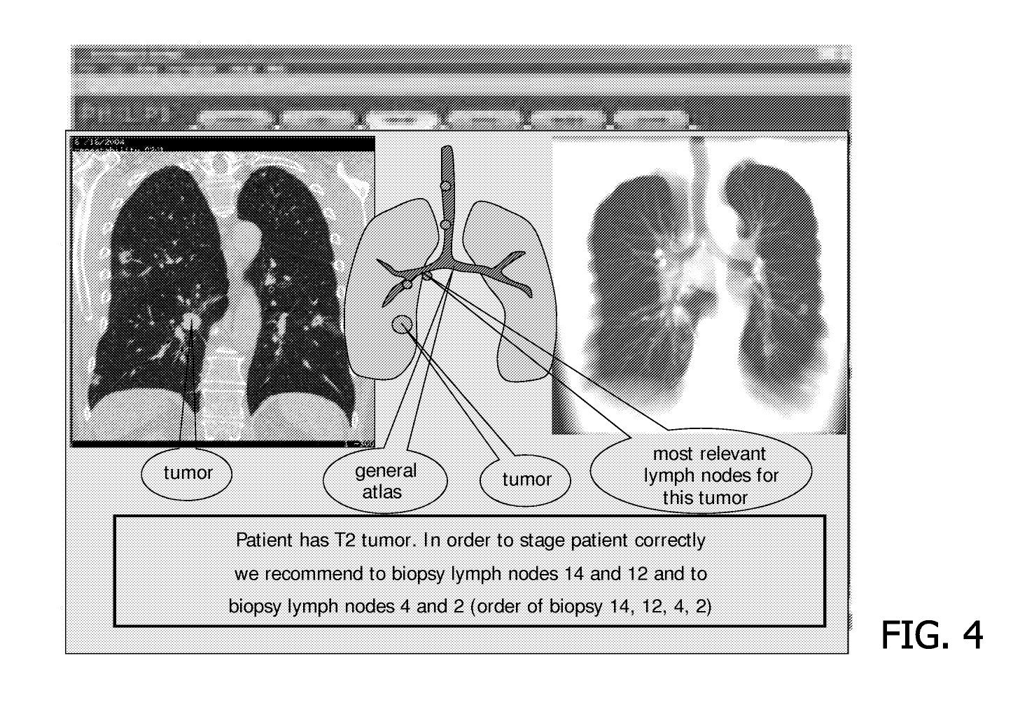

FIG. 4 shows a screen shot of an exemplary recommendation regarding lymph nodes for biopsy.

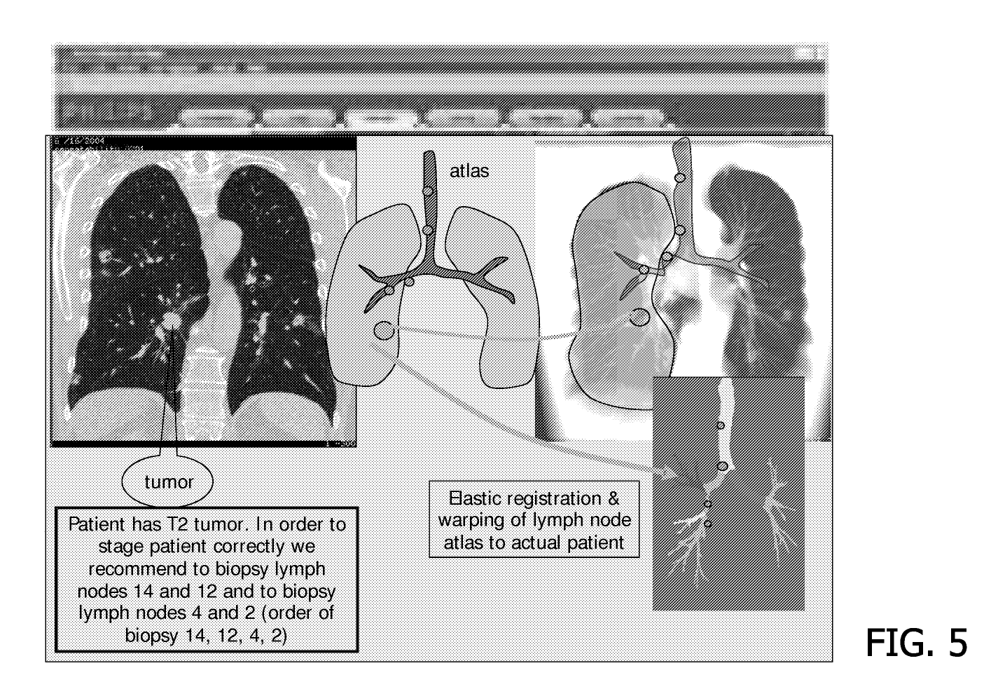

FIG. 5 shows a screen shot of the exemplary recommendation regarding lymph nodes for biopsy relative to a lung segmentation and a bronchial tree extraction.

The exemplary embodiments may be further understood with reference to the following description and the appended drawings wherein like elements are referred to with the same reference numerals. The exemplary embodiments provide a visualization system and method for generating patient-specific recommendations regarding lymph node biopsies, based on the TNM classification system. It will be understood by those of skill in the art that although the exemplary embodiments specifically describe lung cancer staging, the following system and method may be used to provide patient-specific recommendations for cancer staging of other types of cancers.

As shown in FIG. 1, a system 100 according to an exemplary embodiment generates a patient-specific recommendation regarding which lymph nodes should be biopsied for proper cancer staging. The recommendations are at least partly based on rules established by the TNM classification system. The system 100 comprises a processor 102 that is capable of processing medical images such as, for example, chest radiographs and CT scans, to determine the location of specific lymph nodes in the body that should be biopsied to determine the extent of cancer spread. A user interface 104 facilitates user selection of a primary tumor of the patient and instructs the system 100 to recommend an optimal number, position and order of lymph nodes to be biopsied. The system 100 further comprises a display 106 for displaying the medical image and/or displaying the recommendations regarding the lymph nodes to be biopsied and a memory 108 for storing the medical images and or a general atlas of lymph node classifications. The memory 108 may be any known type of computer-readable storage medium. It will be understood by those of skill in the art that the system 100 is, for example, a personal computer, a server, or any other processing arrangement.

As shown in FIG. 2, a method 200 according to an exemplary embodiment comprises loading and displaying a medical image of a patient on the display 106, in a step 210. As shown in FIG. 3, the medical image is, for example, a chest radiograph, a CT scan and/or a bronchial tree extraction image of the patient. The displayed medical image and any other medical images pertaining to the patient are stored in the memory 108. In a step 220, a primary tumor is identified in the medical image. The primary tumor is identified either automatically by the system 100 or manually selected by a user via the user interface 104. Where the tumor is identified by the system 100, the system 100 may prompt the user for confirmation that the correct tumor has been identified. The user enters a confirmation via the user interface 104. The system 100 will continue to identify potential tumors until the correct tumor has been identified and confirmed by the user. Once the tumor is identified, the tumor is classified using the TNM classification system, in a step 230. For example, according to the current version of the internationally accepted TNM classification system, if the tumor is smaller than or equal to 3 cm, the tumor is classified as T1. If the tumor is greater than 3 cm, but smaller than or equal to 7 cm, the tumor is classified as T2. If the tumor is greater than 7 cm the tumor may be classified as T3. If, however, the tumor is greater than 7 cm and additional nodules in the same lobe of the tumor exist, the tumor is classified as T4. It will be understood by those of skill in the art, however, that the size values for classification of the tumor are exemplary only and may be changed, as desired or necessary. Size values that are determinative of tumor classifications are stored in the memory 108. The tumor classification for the identified tumor is also stored in the memory 108. The size values for tumor classification stored in the memory 108 are accessible by the processor 102 when classifying the tumor in step 230.

After the tumor has been identified and classified, the system 100 prompts the user to indicate a next step to be taken. For example, the user may indicate, via the user interface, a request for recommendations regarding lymph node biopsies and/or a request to save, print or display the identified tumor information. When the user indicates the request for lymph node biopsy recommendation, the processor 102 maps the patient medical image to a general atlas, in a step 240. The general atlas includes a model lung and/or bronchial tree with numbered nodal stations, according to the TNM classification system. For example, the current accepted TNM classification system includes fourteen nodal stations that are numbered based upon a location in the lung/bronchial tree. Nodes 1-9 are located in the mediastinum while nodes 10-14 are hilar and intrapulmonary lymph nodes. The patient medical image is mapped to the general atlas such that a corresponding one of the fourteen numbered nodal stations of the general atlas is mapped to lymph node regions in the patient medical image and the tumor identified in the patient medical image is correlated with a corresponding tumor (e.g., by size and position) in the general atlas. It will be understood by those of skill in the art, however, that where a position of the tumor is not a factor in determining recommendations of lymph nodes for biopsy, mapping the patient medical to the general atlas may not be necessary until a later time.

In a step 250, the processor 102 analyzes the general atlas to determine recommendations for an optimal number, location and/or order of lymph nodes to be biopsied based upon predetermined rules. The rules are based upon factors such as, the classification of the primary tumor, a position or distance of the nodal stations relative to the tumor, a position of the lymph node within the body, a position of the nodal stations relative to a drainage area, a staging scheme of the TNM classification system and known information based upon previously staged tumors. For example, according to the currently accepted TNM classification system, nodes 1-9 represent N2 lymph nodes, meaning that if a biopsy of any of these lymph nodes indicates involvement of cancer, the N will be classified as a N2. Nodes 10-14, on the other hand, represent N1 nodes such that if a biopsy reveals cancer involvement in any of the nodes labeled 10-14, the N will be classified as N1. Some of the nodes may also be given an R (right) and L (left) classification depending on the location of the identified tumor. An N3 classification would indicate that the cancer has traveled to a node on a side of the lung opposite of the location of the identified tumor. It will be understood by those of skill in the art that the rules may be defined and/or changed by the user and stored in the memory 108.

In a step 260, the recommendation of lymph nodes to be biopsied is displayed on the display 106, as shown in FIG. 4. The position of the recommended lymph nodes to be biopsied is shown relative to the general atlas and/or the patient image. Where the general atlas was not previously mapped to the patient medical image in the step 240, it will be understood by those of skill in the art that the general atlas may be mapped to the patient medical image prior to displaying the lymph node recommendations. It will also be understood by those of skill in the art that the recommendation is also further displayed as text, as shown in FIG. 4. The user also selects a desired format for viewing the recommendations regarding the lymph node biopsy. The user may elect not to display certain views. Additionally, the user inputs, via the user interface, whether to store the general atlas including the recommendations in the memory 108 and/or to print the recommendations. In a further embodiment, the lung is segmented and/or the bronchial tree extracted from the patient medical image, in a step 270, such that a patient-specific model of the lung is shown. It will be understood by those of skill in the art that the segmentation and/or extraction is conducted using any known segmentation or extraction program.

In a step 280, the general atlas including the recommended lymph nodes to be biopsied are mapped to the lung segmentation and/or bronchial tree extraction to indicate a patient-specific location of each of the recommended lymph nodes. In a step 290, the lung segmentation and/or the bronchial tree extraction showing the corresponding lymph nodes relative to the lung segmentation and the bronchial tree extraction is displayed on the display 106, as shown in FIG. 5. Thus, the user is able to visualize a position of each of the lymph nodes that are recommended to be biopsied relative to a patient-specific model of the lung. It will be understood by those of skill in the art that the patient-specific visualization of each of the recommended lymph nodes to be biopsied relative to the segmented lung and/or bronchial tree will allow the user to properly plan the biopsy process. It will also be understood by those of skill in the art that the user may similarly store and/or print the segmentation including the recommendations regarding the lymph node biopsy.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

What is claimed is:

1. A method, comprising:
identifying (220) a tumor in a patient image;
classifying (230) the tumor based on a predetermined classification system; and
determining (250) a recommendation regarding a lymph node biopsy based on the tumor identified in the patient image, the classification of the tumor and a predetermined rule.

2. The method of claim 1, further comprising:
mapping (240) the patient image to a general atlas including numbered nodal stations.

3. The method of claim 1, further comprising:
displaying (260) the recommendation regarding the lymph node biopsy.

4. The method of claim 1, wherein the predetermined classification system is a TNM classification system.

5. The method of claim 1, wherein the tumor is identified based on one of a predetermined identification rules and a user input.

6. The method of claim 1, further comprising:
segmenting (270) an anatomic structure in which the tumor is located from the patient medical image and mapping the recommendation regarding the lymph node biopsy to the segmented anatomic structure.

7. The method of claim 6, wherein the anatomic structure is a lung, and the method further comprises:
extracting (280) a bronchial tree from the patient medical image and mapping (280) the recommendation regarding the lymph node biopsy to the bronchial tree.

8. The method of claim 1, wherein the recommendation regarding the lymph node biopsy is one of a position, number and order of lymph nodes to be biopsied.

9. The method of claim 1, further comprising:
storing one of the patient image, the general atlas and the recommendation regarding the lymph node biopsy in a memory.

10. A system, comprising:
a display (106) displaying a patient image; and
a processor (102) classifying a tumor displayed in the patient image based on a predetermined classification system and for determining a recommendation regarding a lymph node biopsy based on the tumor in the patient image, the classification of the tumor and a predetermined rule.

11. The system of claim 10, wherein the processor (102) further maps the patient image to a general atlas including numbered nodal stations.

12. The system of claim 10, wherein the display (106) further displays the recommendation regarding the lymph node biopsy.

13. The system of claim 10, wherein the predetermined classification system is a TNM classification system.

14. The system of claim 10, further comprising:
a user interface (104), wherein the tumor is identified by a user input via the user interface (104).

15. The system of claim 10, wherein the processor (102) identifies the tumor based on predetermined identification rules.

16. The system of claim 10, wherein the processor (102) segments an anatomic structure in which the tumor is located from the patient medical image and maps the recommendation regarding the lymph node biopsy to the segmented anatomic structure.

17. The system of claim 16, wherein the anatomic structure is a lung and the processor (102) extracts a bronchial tree from the patient medical image and maps the recommendation regarding the lymph node biopsy to the bronchial tree.

18. The system of claim 10, wherein the recommendation regarding the lymph node biopsy is one of a position, number and order of lymph nodes to be biopsied.

19. The system of claim 10, further comprising:
a memory (108) storing one of the patient image, the general atlas and the recommendation regarding the lymph node biopsy.

20. A computer-readable storage medium (108) including a set of instructions executable by a processor (102), the set of instructions operable to:
identify (220) a tumor in the patient image;
classify (230) the tumor based on a predetermined classification system; and
determine (250) a recommendation regarding a lymph node biopsy based on the tumor identified in the patient image, the classification of the tumor and a predetermined rule.
